(19) United States
(12) Patent Application Publication
(10) Pub. No.: US 2026/0347706 A1
(43) Pub. Date: Nov. 5, 2026

(54) PROCESS FOR THE PRODUCTION OF SYNTHETIC HYDROCARBONS COMPOUNDS BY UTILIZING CARBON DIOXIDE-RICH FEEDSTOCK

(71) Applicant: KT TECH S.P.A., Roma (IT)

(72) Inventors: Luca Basini, Milano (IT); Antonio Batistini, Camaiore (IT); Fabio Ferrari, Comerio (IT)

(21) Appl. No.: 19/488,907

(22) PCT Filed: May 21, 2024
(86) PCT No.: PCT/EP2024/063939

§ 371 Date: Dec. 1, 2025

(30) Foreign Application Priority Data
May 30, 2023 (WO) PCT/EP2023/064418

(51) Int. Cl. C10G 2/00; C01B 3/38; C10K 3/02; C25B 1/04; C25B 15/08

(52) U.S. Cl. CPC C10G 2/34; C01B 3/38; C10K 3/026; C25B 1/04; C25B 15/081; C01B 2203/0261; C01B 2203/062

(57) ABSTRACT

A process to produce synthetic hydrocarbon compounds comprises the steps of: a) producing a syngas by means of a short contact time catalytic partial oxidation process which uses a feedstock comprising a mixture of carbon dioxide included in natural gas and other gases, and carbon dioxide captured from gaseous streams, said carbon dioxide being from 5 to 50% v/v of said mixture; and air, oxygen, air enriched with oxygen, and optionally steam; b) feeding said syngas to a Fischer-Tropsch reactor to produce liquid hydrocarbons by a Fischer-Tropsch process; c) collecting said liquid hydrocarbon compounds from said Fischer-Tropsch reactor. Also described is an apparatus to carry out the process.

The present invention relates to a process for the production of synthetic hydrocarbons compounds by utilizing carbon dioxide-rich feedstock. The invention also relates to an apparatus for carrying out this process.

### BACKGROUND OF THE INVENTION

The CO₂ concentration in the atmosphere has overcome, in 2016, the 400 ppm after having remained between 100 ppm and 300 ppm for thousands of years before, during and after the industrial revolution periods.

The relevance of a combined effort for reducing the usage of fossil fuel and for developing CO₂ utilization solutions incorporating this molecule into fuels, chemicals and materials, was already clear in the 90s, when extensive studies were focused on possible CO₂ utilization pathways based on its physical properties (i.e. supercritical extractions, enhanced oil recovery, various usages as inert gas) and its chemical properties (i.e. for obtaining acetic acid, alcohols and their derivatives, polycarbonates, urea, inorganic carbonates, synthetic natural gas, liquid HC fuels).

However, till nowadays, a negligible amount of the CO₂ produced by industrial activities is used. This occurs because the available processes solutions remain relatively inefficient and costly because they are designed with a poor systemic approach. Despite this, major and continuous efforts are continuing for improving the current situation that will not be sustainable for near future generations.

In view of the foregoing, there is the need of innovative process and technology solutions for consuming CO₂ rich reactant streams, and a task of the present invention is to provide a new process for using CO₂ rich reactant streams in a process that includes the Fischer-Tropsch (F-T) synthesis to produce liquid hydrocarbons compounds and olefins.

Indeed, this is a particularly complex task since it requires the initial conversion of the CO₂ molecules into synthesis gas whose main components are CO and H₂ in a ratio that for the F-T processes, need to be close to 2 v/v. More in detail, F-T catalytically converts the synthesis gas into a spectrum of hydrocarbon chains, including a fraction of oxygenates (see equations 1-3 below), while the water gas shift reaction (WGS, see equation 4 below) may also occur, depending on the catalyst affecting the syngas composition and final product distribution.

n CO+(2n+1) H₂→CₙH₂ₙ₊₂+n H₂O [1]

n CO+2n H₂→CₙH₂ₙ+n H₂O [2]

n CO+2n H₂→CₙH₂ₙ₊₂O+(n−1) H₂O [3]

CO+H₂O→CO₂+H₂ [4]

Selection of catalyst and optimization of both reactor configuration and process parameters allows to maximize efficiency and achieve desired product selectivity. It is briefly mentioned that F-T reactor solutions are: i) slurry bubble column (SBCR), ii) multi-tubular trickle-bed, iii) circulating fluidized-bed, and iv) fixed fluidized-bed reactors.

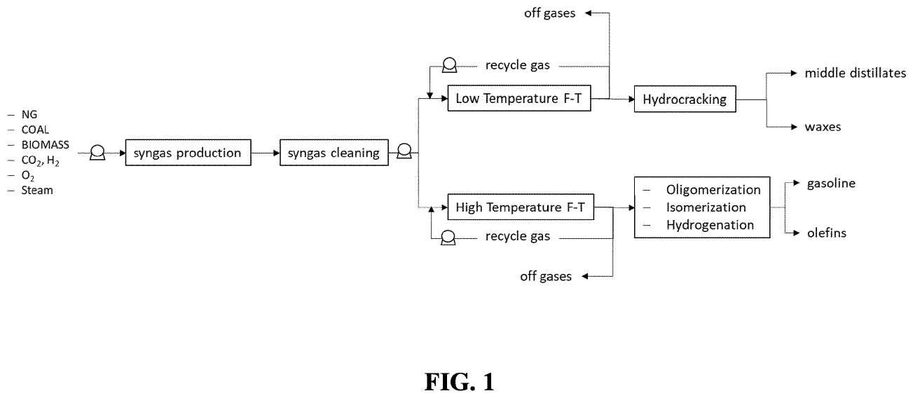

FIG. 1 includes a simplified scheme with the main unit operations of the F-T processes, with indications of the reactants and the achievable products.

Briefly, it is mentioned that feedstock is converted into synthesis gas (syngas) that is purified and sent to the F-T reactors that, depending on their operation condition, design and catalysts used, can originate linear hydrocarbons (low temperature F-T) or branched hydrocarbons (high temperature F-T). These hydrocarbons are subjected to hydrotreating, oligomerization, isomerization, hydrogenation steps to originate: i) middle distillates (i.e., gasoils), ii) waxes, iii) gasoline, iv) olefins.

Noteworthy, in order to include CO₂ into the products achievable with the F-T processes, it is necessary not only to convert this molecule into synthesis gas (i.e., CO and H₂) but also to avoid or to reduce the CO₂ emissions associated to: i) the reactant/reaction heating, ii) the compression steps, iii) the recycle flow of the unconverted synthesis gas of the F-T loop and iv) the purge of the gaseous hydrocarbon molecules (e.g. CH₄) and CO₂ molecules, not useful to the F-T synthesis, for avoiding their build-up in the F-T reactant recycle loop.

For what concerns the production of synthesis gas from CO₂ containing streams, it is noted that two reactions, named as reverse water gas shift (RWGS) reaction [5] and/or dry reforming reaction [6] can be utilized:

CO₂+H₂→CO+H₂O ΔH°=42 kJ/mol [5]

CH₄+CO₂→2CO+2 H₂ ΔH°=247.3 kJ/mol [6]

However, these two reactions require high temperatures to occur and, particularly reaction [6], that is strongly endothermic, also require an extremely high energy input.

More in detail, it is noted that the RWGS reaction [5] requires, for achieving a good CO₂ conversion and for avoiding methane production through equations [7] and [8] temperatures; typically, above 850 °C.

CO+3 H₂→CH₄+H₂O ΔH=−206 kJ/mol [7]

CO₂+4 H₂→CH₄+2H₂O ΔH=−164 KJ/mol [8]

### PRIOR ART

Indeed, a solution, known as CAMERE process, aiming at the production of methanol, was demonstrated till a relatively large pilot scale but did not result into a viable industrial technology since the integration of a RWGS operating at high temperature (ca. 900 °C) and pressure (ca. 30-50 ATM) required the usage of a furnace emitting CO₂ containing gases that contributed on the overall net production of CO₂ per ton of produced methanol. The weaknesses of the original CAMERE processes could be improved by utilizing electrified RWGS reactors (E-RWGS) and H₂ produced from steam/water electrolysis, but also in this case minor CO₂ positive emissions, between 0.04-0.15 per ton of produced methanol, would be produced. Only the usage of CO₂ contained in a bio-gas source and of electric energy sources with a carbon footprint lower than 120gCO₂/kWh would determine negative CO₂ emissions.

Another solution that partially improves the emissions associated to the RWGS heated by an external furnace is the autothermal reverse water gas shift (A-RWGS) reactor that includes a burner followed by a catalytic bed. In this case some O₂ is mixed to the CO₂ and flowed inside the burner at high temperatures. The O₂ streams combust a portion of the H₂ and, if present, the hydrocarbon molecules, releasing the heat required for raising the reaction temperature above 850 °C.

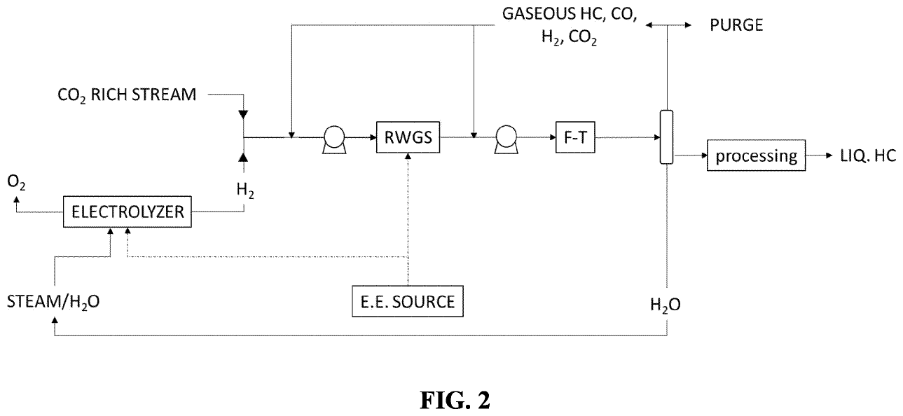

FIG. 2 includes a simplified and “state of the art” process scheme integrating RWGS and F-T unit operations. In this scheme the source of H₂ to be mixed with the CO₂, is steam electrolysis (e.g., Alkalyne Electrolysis—AE, Proton Exchange Membrane Electrolysis PEME, Solyd Oxide Elkectrolyzer Cell—SOEC) that also produces an O₂ flow that is vented. Noteworthy, with the AE term we synthetically describe the alkaline water electrolyzers which also include technologies utilizing solid polymeric membrane electrolytes also referred to as Alkaline Electrolyte Membrane (AEM) electrolyzers.

The scheme also considers that the tail gases of the F-T reactor can be either recycled to F-T reactor itself and/or combined with the H₂ and the CO₂ rich flow for being sent to the RWGS reactor. The obtained syngas mixture is then compressed prior to being fed to the F-T Synthesis Unit. Noteworthy, this process will require to purge the tail gas recycle for avoiding the build-up of small (C1-C5) hydrocarbon molecules and CO₂ in the F-T recycle loop.

For what concerns the CO₂ reforming reaction [6], as already mentioned, this reaction not only requires high temperatures, but it is also highly endothermic. Moreover, currently, only steam-CO₂ reforming technologies, are industrially available and their reactants mixture composition and their operation conditions, particularly at high pressure, are limited by carbon formation reactions. In other words, the steam-CO₂ reforming technologies are limited by thermodynamic and kinetic affinity towards carbon formation reactions occurring at the surfaces of the cataly sts.

The occurrence of carbon formation reactions determines limitations in the operation conditions; these limitations particularly affect the possibility of lowering or avoiding the steam content in the reactant mixtures. More in detail, the carbon formation reactions are particularly relevant at pressures between 15-40 ATM.

2 CO=CO₂+C ΔH°=−171 kJ/mol [9]

CO+H₂=H₂O+C ΔH°=131 kJ/mol [10]

CH₄=2 H₂+C ΔH°=75 kJ/mol [11]

CₙHₘ (g)=olefins (g)=coke(s) [12]

Indeed, particularly reactions [9] and [11-12] are the primary sources of carbon that can be divided into three typologies: i) whisker carbon, ii) gum (encapsulating carbon), and iii) pyrolytic carbon.

Gum formation and pyrolytic carbon are especially associated with the presence of hydrocarbons with more than two carbon atoms in the feedstock and can be avoided by removing these molecules with a pre-reformer unit upstream dry reforming.

Instead, the production of whisker carbon can only be avoided by operating in condition having a low thermodynamic affinity towards this species which, once formed, brings to the catalyst pellet destruction and to the plant shut down due to the necessity of avoiding that the heat flow from the furnace not adsorbed by the endothermic reactions could lead to tubes overheating and fracturing.

Therefore, one of the primary tasks in the development of a low steam, steam-CO₂ reforming processes, is the careful theoretical and experimental analysis of the allowed carbon-free operating conditions.

Nickel, cobalt, and noble metal catalysts, among others, have been extensively studied as potential catalysts for steam-CO₂ reforming, with nickel and particularly Ni-Mg and Ni-Mg-Al mixed oxide systems deposited on an alumina support, being the most investigated system, as Ni catalysts, cost-wise, are the most attractive catalyst. Noble metal catalysts are also utilized since they typically have a lower kinetic affinity for carbon formation and a higher activity for steam-CO₂ reforming reactions.

In addition, it is noted that the CO₂ consumption features in steam-CO₂ reforming is also limited by the emissions determined by the heating furnaces. Indeed, the CO₂ reforming reaction [6] requires ca. 22% of enthalpy more than steam reforming [13] and this heat is currently provided in heating furnaces with reactions such as [14]

CH₄+H₂O=3H₂+CO ΔH°=+206 kJ/mole [13]

CH₄+2O₂+4N₂=CO₂+2H₂O+4N₂ ΔH°=−802 kJ/mole [14]

Since the heat transferred into the reaction inside the reforming tubes is roughly the 50% of the heat released by the combustion reactions [8], it can be estimated that per any CO₂ molecule consumed with reaction [6] ca 0.6 CO₂ molecules would be produced when the reaction heat is provided by burning CH₄ molecules. This, if added to the heating and compression requirements of the reactant mixture that also contains relevant amounts of steam, does not allow to steam-CO₂ reforming technologies to become efficient “CO₂ utilization machines”.

Despite these difficulties, some companies have defined and commercialize steam-CO₂ reforming processes in which some steam addition prevents the above-mentioned carbon formation reactions, while pure dry reforming is not currently available.

In conclusion, it is mentioned that TOPSOE A/S has also developed a process solution in which a hot CO₂ containing stream is added to the synthesis gas produced by a steam reformer operating at low steam vs. carbon ratios. In this way a CO₂ enriched synthesis gas is transformed in a subsequent Adiabatic POst Converter (APOC) reactor in conditions in which the thermodynamic affinity towards the carbon formation reactions is greatly reduced. Indeed, in the APOC reactor the CO₂ is transformed with a reverse water gas shift reaction into CO and H2O. The use of the APOC provides then a method for tailoring a synthesis gas composition in a wide range of H₂ vs CO ratio minimizing the risk of carbon formation.

However, it is noted that these steam-CO₂ reforming processes are not currently used for producing the synthesis gas for F-T synthesis reactors.

WO 2016/016256 A1 discloses an integrated SCT-CPO/ATR process for the production of synthesis gas that can be used in Fischer-Tropsch processes. There is no disclosure of producing syngas via reverse a water gas shift reaction and combining said syngas with syngas produced via the SCT-CPO process. Furthermore, there is no disclosure of a SCT-CPO reactor with the specific structure disclosed in the present application.

US 2010/294994 A1 describes a process for the production of syngas by means of a reactor provided with four sections (I, II, III, IV, FIG. 2) in which the first and the second zones include: i) a device for the nebulization of a liquid hydrocarbon feedstock and ii) a nebulization and mixing chamber for providing a reactant mixture that is subsequently converted into synthesis gas in a reaction zone included in section III having a cylindrical shape and layered catalytic structures for converting the mixture of nebulized liquid hydrocarbons with the oxidant flow.

### BRIEF DESCRIPTION OF THE INVENTION

An aspect of the present invention is a process to produce hydrocarbon compounds by converting syngas by means of a Fischer-Tropsch process, characterized in that said syngas comprises a part produced by means of a short contact time catalytic partial oxidation process and a part produced by reverse water gas shift process; wherein:
A) said short contact time catalytic partial oxidation process uses a feedstock comprising:
   i) a first stream comprising a mixture comprising carbon dioxide included in one or more of natural gas, associated gases, off-gases of industrial activities, biogas, blast furnace gases, coke oven gases, direct reduction gases and carbon dioxide captured from gaseous streams, said carbon dioxide being from 5 to 50% v/v of said mixture;
   ii) a second stream comprising oxygen or air enriched with oxygen, and optionally steam; wherein:
      said oxygen is obtained from electrolysis of water and from air; and
      said electrolysis of water or steam produces also hydrogen which is mixed to the syngas and fed to said Fischer-Tropsch process;
   iii) a third-stream comprising tail gas released from said Fischer-Tropsch process; said short contact time catalytic partial oxidation process is carried out in a reactor on a catalytic bed comprising a portion with truncated cone geometry operated at a gas hourly space velocity from 15,000 to 500,000 h⁻¹;
B) said reverse water gas shift process uses a feedstock comprising a mixture of hydrogen and carbon dioxide, wherein:
   i) said carbon dioxide is from 10 to 70% v/v of said mixture;
   ii) said hydrogen is from 10 to 70% v/v of said mixture and is optionally produced by the water/steam electrolysis section.
C) said liquid hydrocarbon compounds are collected from a Fischer-Tropsch reactor in which said Fischer-Tropsch process is carried out.

Another aspect of the invention is an apparatus for producing synthetic hydrocarbon compounds with the process defined above, comprising a short contact time catalytic partial oxidation reactor including a first portion having a cylindrical shape consisting of an inlet a mixing zone and a thermal shield zone, a second portion containing a catalytic bed having a truncated cone shape, and a third portion having a cylindrical shape with a diameter greater than the diameter of said first cylindrical portion, followed by a second thermal shield zone, wherein:
a) in said second portion having the shape of a truncated cone the upper base is smaller than the bottom base;
b) said upper base of said truncated cone is joined to said first cylindrical portion and said bottom base is joined to said third cylindrical portion; and
c) the external angle (α) of said truncated cone at the upper base is lower than 85° and preferably lower than 75°.

The term “associated gas” designates a gas produced as a byproduct of the production of crude oil. Associated gas is generally regarded as an undesirable byproduct, which is either reinjected, flared, or vented.

The term “off-gas” designates a gas produced as a byproduct of a chemical process.

The term “tail gas” designates gases and vapors released into the atmosphere from an industrial process after all reactions and treatments have taken place.

The term “electrolysis of steam” or “steam electrolysis” means the High-temperature electrolysis; as known in the field.

Noteworthy, the SCT-CPO reactor has the unique features described above that allow the utilization of CO₂ rich feedstock and of the F-T tail gases and off-gases produced in the separation and/or upgrading of the primary F-T products for producing a synthesis gas that will be utilized in the F-T synthesis. This allows the incorporation of carbon dioxide in the reaction products as it will be described in the following detailed description of the invention. This CO₂ utilization would not be allowed by the existing synthesis gas production technologies due to: i) the occurrence of carbon formation reactions [9-12] and ii) the possibility allowed only by SCT-CPO to avoid heating furnaces for pre-heating the reaction mixture and consequently avoiding CO₂ emissions in the heating furnaces.

### DETAILED DESCRIPTION OF THE INVENTION

The invention is described also with reference to the accompanying drawings, wherein:

FIG. 1 is a simplified state-of-the-art process scheme with the main unit operations of the via F-T processes and indications on the reactants and the achievable products.

FIG. 2. is a simplified “state of the art” process scheme integrating RWGS or E-RWGS or A-RWGS and F-T unit operations for transforming CO₂ rich streams into synthesis gas to be used in F-T reactors. Noteworthy, in this scheme the source of H₂ to be mixed with the CO₂ is steam electrolysis (AE, PEM, SOEC) that also produce an O₂ flow that is vented.

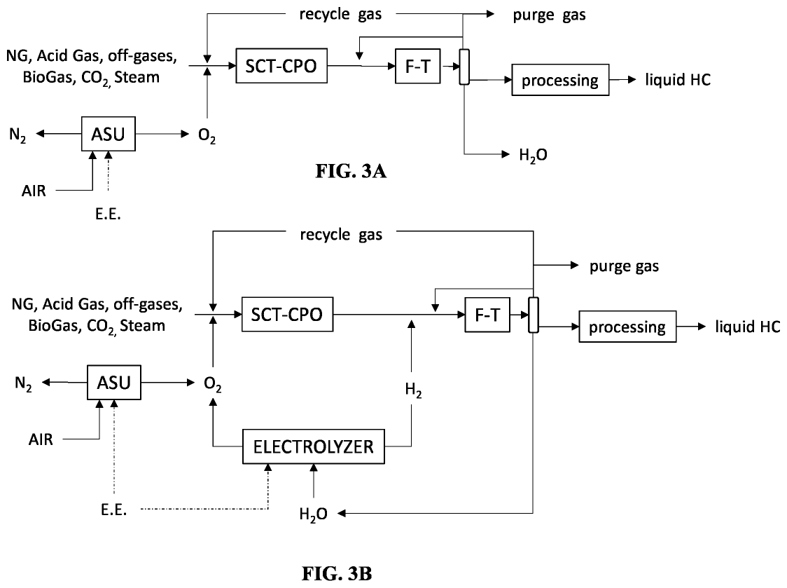

FIG. 3 is a general description of a state-of-the-art process (A) and of the innovative process (B) in which the SCT-CPO reactor is integrated with steam/water electrolysis (AE, PEME, SOEC), for processing CO₂ rich reactant stream with CO₂ molecules included either in a make-up gas and/or in the F-T off-gases for minimizing the purge gas emissions.

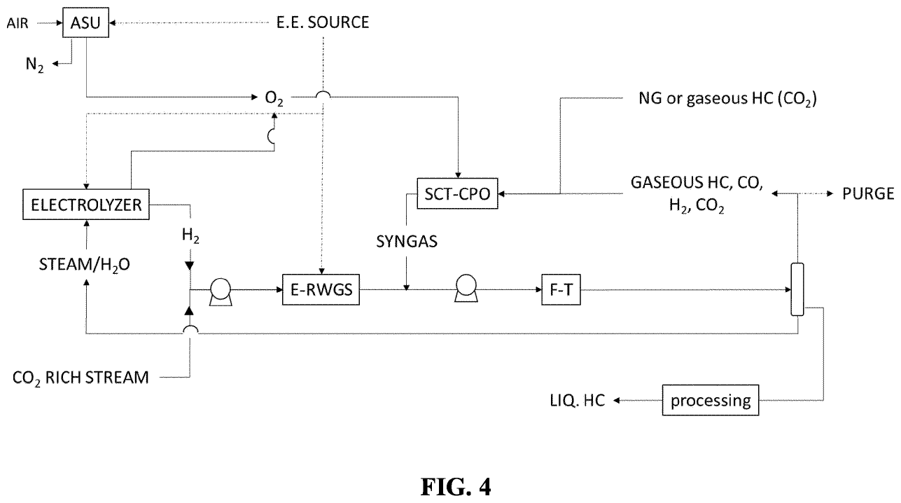

FIG. 4 is a process scheme for converting CO₂ rich streams into the production of liquid hydrocarbons, via SCT-CPO, through the intermediate formation of a syngas by combining E-RWGS and SCT-CPO. Noteworthy, the syngas produced by SCT-CPO is obtained entirely from the purge gas of the F-T recycle loop. In case that all the F-T recycle gas is sent to SCT-CPO the purge gas is completely avoided.

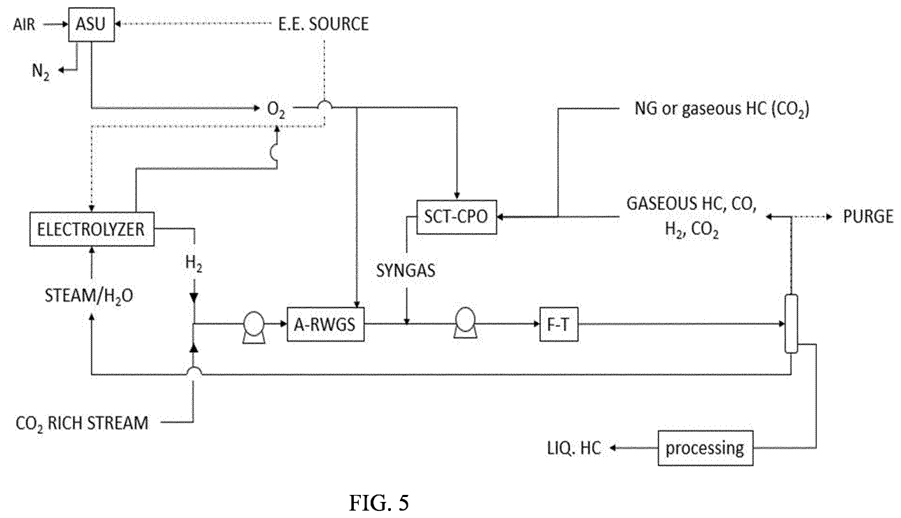

FIG. 5 is a process scheme for converting CO₂ rich streams into the production of liquid hydrocarbons, via SCT-CPO, through the intermediate formation of a syngas by combining A-RWGS and SCT-CPO. Noteworthy, the syngas produced by SCT-CPO can be obtained entirely from the purge gas of the F-T recycle loop, or by the combination of purge gas from F-T with natural gas and/or other gaseous hydrocarbons. In case that all the F-T recycle gas is sent to SCT-CPO the purge gas is completely avoided.

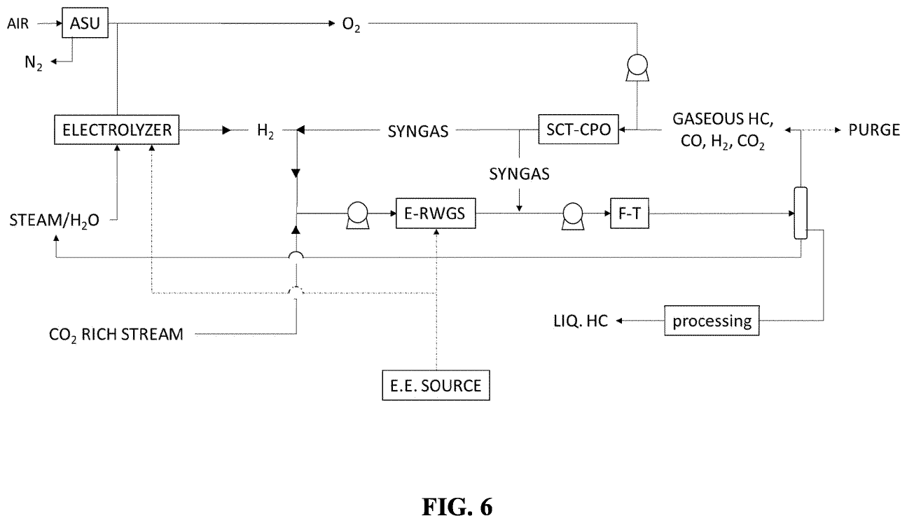

FIG. 6 is a process scheme for converting CO₂ rich streams into the production of liquid hydrocarbons, via SCT-CPO, through the intermediate formation of a syngas by combining E-RWGS and SCT-CPO. In this scheme the syngas produced by SCT-CPO is obtained by mixing gaseous hydrocarbon stream also including CO₂ and all or part of the F-T recycle loop. In case that all the F-T recycle gas is sent to SCT-CPO the purge gas is completely avoided.

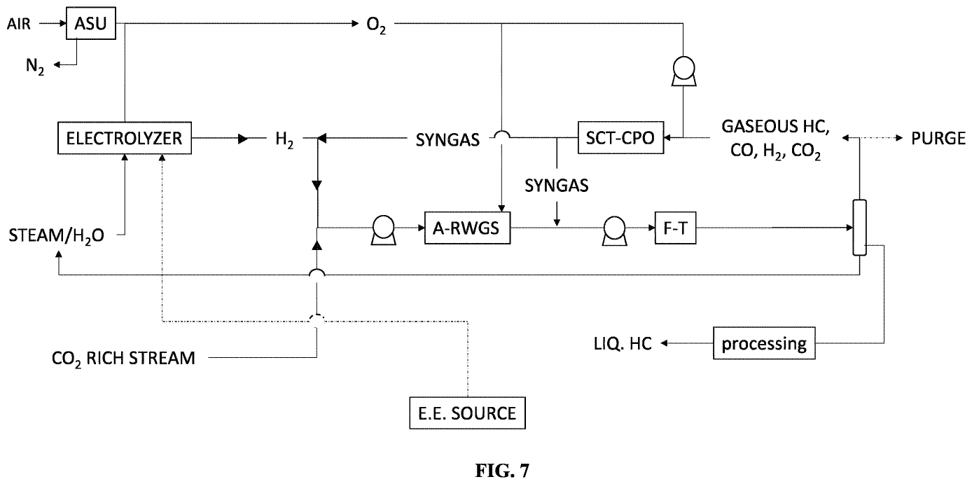

FIG. 7 is a process scheme for converting CO₂ rich streams into the production of liquid hydrocarbons, via SCT-CPO, through the intermediate formation of a syngas by combining A-RWGS and SCT-CPO. In this scheme the syngas produced by SCT-CPO is obtained by mixing gaseous hydrocarbon stream also including CO₂ and all or part of the F-T recycle loop. In case that all the F-T recycle gas is sent to SCT-CPO the purge gas is completely avoided.

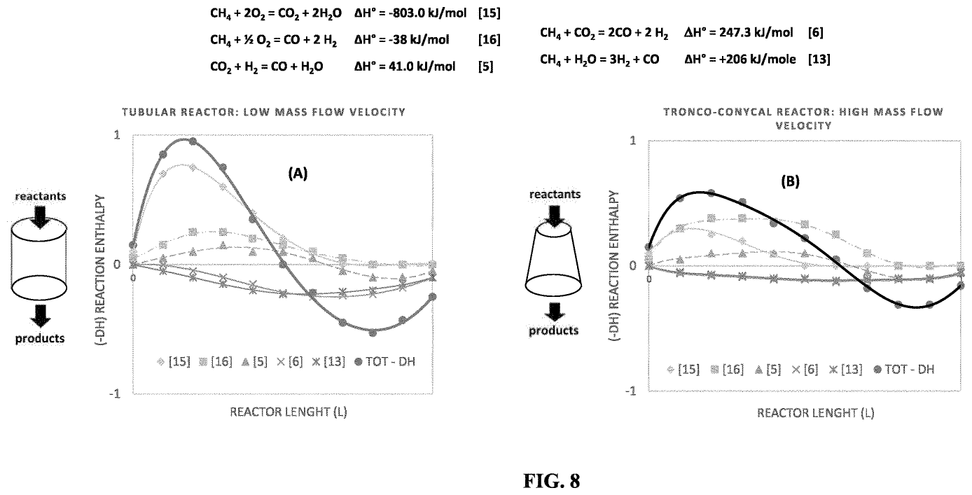

FIG. 8(A) is a qualitative drawing of the enthalpy/temperature contributions determined by reactions [15], [16], [5], [6] and [13] occurring along a tubular reactor including a fixed catalytic bed operated at low mass flow velocity; the solid line represents the total enthalpy variation.

FIG. 8(B) is a qualitative drawing of the enthalpy/temperature contributions determined by reactions [15], [16], [5], [6] and [13] occurring along a truncated cone geometry including a fixed catalytic bed operated at high mass flow velocity; the solid line represents the total enthalpy variation.

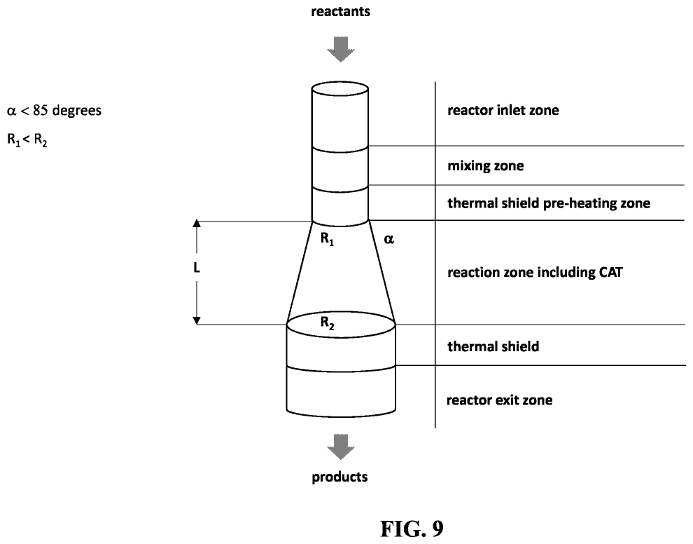

FIG. 9 is a scheme of the internal zones of a SCT-CPO reactor with a truncated cone reaction zone with elements on the geometry of the truncated cone zone

FIGS. 3, 4, 5, 6 and 7 include schematic drawings describing the process according to the invention.

The process and apparatus according to the present invention overcome the steam-CO₂ reforming and the dry reforming drawbacks related to the occurrence of carbon formation reactions and reduce the relevance of the RWGS and hence the H₂ requirements. This is done by utilizing short contact time—catalytic partial oxidation (SCT-CPO) reactors integrated in process solutions that allow the CO₂ conversion into syngas and the avoidance or the strong reduction of the purge flow of the F-T recycle loop since this purge can also be utilized in the SCT-CPO feedstock.

The innovative process solutions here described also allow the utilization of the co-produced O₂ stream associated to the H₂ production with steam/water electrolysis.

This SCT-CPO reactor is particularly advantageous for utilizing CO₂ rich feedstock since the reactivity features and operation conditions are not limited by the carbon formation reactions affecting the steam-CO₂ reforming reactors.

Instead, the presence of the CO₂ in the SCT-CPO reactor has an inhibiting effect towards the parasitic gaseous phase radical reactions that, particularly in high pressure conditions, are the only reactions that could lead to unsaturated hydrocarbon molecules formation that could possibly aggregate and decompose for producing carbonaceous deposits.

More in detail, with the here described SCT-CPO reactor solutions, we have found that:
i) the presence of CO₂ in the reactant mixture inhibits the propagation of the unselective radical reactions inside the reactant/product gaseous mixture progressing inside the SCT-CPO reactor.
ii) the CO₂ participates the heterogeneous chemistry inside the catalytic bed after that relevant amounts of hydrocarbons have been already transformed into synthesis gas.
iii) the CO₂ reacts with the produced H₂ through an internal RWGS in the last section of the SCT-CPO reactor catalytic bed.

Noteworthy, only the reactor structure according to the invention is effective for producing these reactivity features while other CPO reactors utilizing tubular and fixed bed reactors, fluidized bed, moving beds, or bubbling bed reactors cannot be applied in the conditions here described.

Moreover, it is noted that the SCT-CPO technology is discussed in numerous patent documents, including WO2016016257 (A1), WO2016016256 (A1), WO2016016253 (A1), WO2016016251 (A1), WO 2011151082, WO 2009065559, WO 2011072877, US 2009127512, WO 2007045457, WO 2006034868, US 2005211604, WO 2005023710, WO 9737929, EP 0725038, EP 0640559. Extensive technical and scientific literature has also been produced and mentioned in the following references:
“Issues in H₂ and synthesis gas technologies for refinery, GTL and small and distributed industrial needs”; Basini, Luca, Catalysis Today, 106 (1-4), p. 34, Oct 2005.
“Fuel rich catalytic combustion: Principles and technological developments in short contact time (SCT) catalytic processes”; Basini, L.; Catalysis Today, 117 (4), 384-393; DOI: 10.1016/j.cattod.2006.06.043 Published: 15 Oct. 2006
“Natural Gas Catalytic Partial Oxidation: A Way to Syngas and Bulk Chemicals Production |IntechOpen”; G. Iaquaniello, E. Antonetti, B. Cucchiella, E. Palo, A. Salladini, A. Guarinoni, A. Lainati and L. Basini; http://dx.doi.org/10.5772/48708
“Short Contact Time Catalytic Partial Oxidation (SCT-CPO) for Synthesis Gas Processes and Olefins Production”; L. E. Basini, A. Guarinoni, Ind. Eng. Chem. Res. 2013, 52, 17023-17037; https://doi.org/10.1021/ie402463m

The term “short contact time catalytic partial oxidation” (SCT-CPO) has a well-defined meaning either in the scientific, technical, and patent literature. As used in the present invention, however, certain aspects are quite specific for what concerns the combination of the characteristics of the reactor and the operation conditions.

We have found that the utilization of specific SCT-CPO reactors and operation conditions, improves the possibility of transforming CO₂ rich stream into a H₂ and CO rich syngas for producing chemical and fuels while completely avoiding the occurrence of conditions in which the carbon formation reactions are produced either for kinetics or thermodynamic reasons in steam-CO₂ reforming reactor.

Moreover, we have found that, inside the here described SCT-CPO reactors, the CO₂ reacts mainly through the reverse water gas shift (RWGS) reaction in the last section of the catalytic bed after that the gaseous hydrocarbons and the oxygen containing flows have been largely converted into a mixture of H₂ and CO. In this way, in the same SCT-CPO reactor, it is possible to obtain the results that would have been obtained by combining the steam-CO₂ reforming or dry reforming and APOC reactors, but in conditions in which the carbon formation reactions [9-12] do not occur.

It is also mentioned that SCT-CPO technology requires moderate pre-heating of the reactant mixtures, and the heat required for this moderate pre-heating can be obtained by recovering the heat contained in the synthesis gas, hence avoiding the utilization of fire heaters and avoiding the CO₂ emissions that this use would produce.

The use of the specific solutions for SCT-CPO reactors, and operation conditions, would then provide a unique mean for obtaining CO and H₂ rich syngas production suitable for chemical and fuel products with F-T by integrating substantial amounts of CO₂ into the final products. More specifically, it has been found that the SCT-CPO based technology solutions, here described, allow the utilization of hydrocarbon feedstock also including relevant amounts of CO₂. Indeed, the CO₂/C v/v in the hydrocarbon feedstock can be comprised between 0-1.5 v/v and preferentially between 0.2-1.0 v/v) in a wide range of pressure (1-80 ATM and preferentially between 5-50 ATM) and temperature (inlet temperatures comprised between 100 and 500 °C and preferentially between 150 and 400 °C) without incurring in the carbon formation reactions.

Noteworthy, the SCT-CPO reactor feedstock may include the F-T recycle gas stream with no or minor amounts of fresh gaseous HC feedstock. This allows the conversion into synthesis gas of the small hydrocarbon molecules and of the CO₂ that do not participate to the F-T reactions and that will build up in the F-T recycle loop, thus requiring purge gas emissions. Particularly the process solutions integrating: i) E-RWGS or A-RWGS, ii) SCT-CPO, iii) F-T and iv) electrolyzers (as described in FIGS. 4-7) allow unique possibility of including CO₂ and CO₂ containing streams into hydrocarbon compounds with very effective CO₂ sink process solutions.

It is also reported that the SCT-CPO reactor here described with a truncated cone geometry of the catalytic bed can operate at Gas Hourly Space Velocity Values comprised between 15,000-500,000 h⁻¹ and preferentially between 30,000-250,000 h⁻¹.

The catalysts can be any suitable material comprising a support with a pelletized or a monolith structure having active metal species onto their external surface. Examples of these catalysts are included in WO 2022/263409 A1.

The possibility of complete utilization of the F-T unconverted gaseous stream is particularly useful for single pass F-T reactors.

It has also been found that the process and apparatus of the invention allow the operation of SCT-CPO reactors with a moderate pre-heating of the reactants that can be provided with gas-gas heat exchangers recovering the heat from the produced synthesis gas.

For what it concerns the RWGS, E-RWGS, A-RWGS reactors, it is mentioned that they can be operated at pressures comprised between 1-100 ATM and preferentially between 20-80 ATM), and temperatures between 850-1200 °C and preferentially between 900-1050 °C. The catalysts may be any suitable transition metal oxide for example, Nickel Oxide, Iron Oxide, Chromium Oxide. The H₂/CO₂ ratios may be comprised between 0.5 and 2.5 v/v and preferentially close to 1.0 v/v depending on the desired composition of the synthesis gas and the GHSV values can be comprised between 3,000-50,000 h⁻¹.

In this way the combination of the above-mentioned technologies allows the CO₂ utilization as a synthon for obtaining a syngas with suitable H₂ vs CO ratio for utilization in the F-T synthesis.

The F-T synthesis step may comprise one or more F-T reactors including F-T catalysts and can be performed according to anyone of the known processes, using anyone of the known catalysts such as those including Iron or Cobalt active species.

As already mentioned, (see FIG. 1) the F-T steps can be differentiated between high-temperature processes with reaction temperatures typically between 320-360 °C and low-temperature processes, with reaction temperatures typically between 220-250 °C.

The high-temperature processes typically utilize catalysts containing Iron species and utilize a synthesis gas with H 2/CO ratios between 0.8-2.0 v/v and preferentially between 1.2-1.8 v/v.

The low-temperature F-T processes utilize catalysts containing Cobalt species and utilize a synthesis gas with H₂/CO ratios between 1.8-2.5 v/v and preferentially between 1.9-2.2 v/v. Pressures can be comprised between 1-100 ATM and preferentially between 10-80 ATM.

The GHSV values may be comprised between 1,000-25,000 h⁻¹, depending on the reactor solutions, namely fixed-bed, slurry-phase, bubble column reactors.

Noteworthy the described process solutions also utilize H₂ and O₂ sources such those produced by steam and water electrolysis and in some process configurations, integrate the syngas production obtained with SCT-CPO with the syngas production obtained by a RWGS reactor and particularly by a E-RWGS or A-RWGS reactors.

FIG. 3 (A) shows how the SCT-CPO and F-T steps can integrate by feeding the SCT-CPO reactor with part of the F-T loop recycle gas for reducing or avoiding the purge gas emissions.

FIG. 3 (B) shows how the scheme can be further implemented with steam or water electrolysis. In this case the amount of the CO₂ in the reactant flow and the addition of H₂ to the produced synthesis gas are balanced for reaching the H₂/CO ca. 2 v/v before entering in the F-T reactor.

The oxygen from air is obtained by means of a method selected from a cryogenic air separation unit (ASU), or other methos such as vacuum pressure swing adsorption, membrane separation.

The O₂ co-produced by steam or water electrolysis is fed to the SCT-CPO reactor. Noteworthy, the gaseous hydrocarbon feedstock can be composed by natural gas, liquefied petroleum gas (LPG), naphtha and/or gaseous mixtures having a biomass origin, and/or gaseous mixtures produced by other industrial activities; such as refinery off-gases, gaseous feedstock associated to chemical and petrochemical productions, gaseous feedstocks associated to oil productions (designated as “associated gases”), gaseous feedstocks associated to the iron and steel productions such as blast furnace gases (BFG), coke oven gases (COG), direct reduction gases (DRG).

FIGS. 4 and 5 shows how the F-T, SCT-CPO, E-RWGS or A-RWGS and steam or water electrolysis can be integrated by feeding the SCT-CPO reactor only with part or all the F-T recycle gas for reducing or completely avoiding any purge gas stream.

The feedstock fed to the RWGS reactor may contain a mixture of carbon dioxide in which the carbon dioxide is from 10 to 70% and the hydrogen is from 10 to 70% v/v of the mixture, which optionally comprises also hydrogen contained in the syngas produced in the short contact time catalytic partial oxidation reactor.

FIGS. 6 and 7 shows how the F-T, SCT-CPO, E-RWGS or A-RWGS and steam or water electrolysis can be integrated by feeding the SCT-CPO reactor either with hydrocarbon feedstocks that are gaseous at the reactor inlet temperatures and with part or all the F-T recycle gas for reducing or completely avoiding any purge gas stream. As above mentioned, the gaseous hydrocarbon feedstock can be composed by natural gas, liquefied petroleum gas (LPG), naphtha and/or gaseous mixtures having a biomass origin, and/or gaseous mixtures produced by other industrial activities; such as refinery off-gases, gaseous feedstock associated to chemical and petrochemical productions, gaseous feedstocks associated to oil productions, gaseous feedstocks associated to the iron and steel productions such as blast furnace gases (BFG), coke oven gases (COG), direct reduction gases (DRG).

To explain the reactivity features that are produced with the SCT-CPO reactors and that allows the integration of this technology with the innovative process schemes that are here proposed we report the following information.

The thermo-chemical properties of the reaction environment produced in short contact time conditions during the SCT-CPO in a heterogeneous catalytic fixed bed reactor fed with a premixed CH₄, Steam, CO₂ and O₂ stream, can be discussed considering the system composed by the by equations [15-16], [4], [6], [13]

CH₄+2O₂=CO₂+2H₂O ΔH°=−803.0 kJ/mol [15]

CH₄+½ O₂=CO+2 H₂ ΔH°=−38 kJ/mol [16]

CO₂+H₂→CO+H₂O ΔH°=41.0 kJ/mol [5]

CH₄+CO₂=2CO+2 H₂ ΔH°=247.3 kJ/mol [6]

CH₄+H₂O=3H₂+CO ΔH°=+206 kJ/mole [13]

The exothermic total oxidation reaction [15] has the highest probability to occur at the beginning of the bed, while the endothermic steam-CO₂ reforming reactions [6] and [13] and the mildly endothermic (RWGS) reactions [5] would have the highest probability to occur in following zone. Noteworthy by increasing the reaction temperature above 830 °C reaction [5] is shifted on the right side and favoured with respect to steam-CO₂ reforming [6] and [13].

However, we found that the extent and the localization of these reactions inside the catalytic bed is greatly affected by physical and chemical factors. Total combustion [15] has been found be the most competitive reaction on noble metal base (Rh, Ru, Ir, Pt, Pd) catalysts at “relatively low temperatures” below 750 °C and at high O₂ partial pressure.

These are typically the conditions produced at the beginning of the catalytic beds in tubular reactors operated at “high” contact time values (e.g., above 1 s). In these cases, we found that the thermal profiles of the reaction environments are determined by the strongly exothermic reaction [15] with a minor contribution of reactions [16] and [4], followed by the strongly endothermic steam-CO₂ reforming reactions [6] and [13].

These conditions originate very large axial temperature gradients and moreover, the energy release associated to total combustion also determines the propagation of the heterogeneous reactions into the gaseous phase originating a rather unselective radical chemistry leading to unsaturated molecules and soot formation.

Indeed, we have found that with tubular reactors the catalytic partial oxidation reactions cannot be performed at high pressures since reaction [15] cannot be controlled and propagate reactions into the gaseous phase with the risk of flame ignition particularly at high pressure (e.g., above 10 ATM) but in any case, producing some radical reactions leading to the formation of unsaturated hydrocarbons precursors of solid carbonaceous compounds.

Instead, it has been found that it is possible that the solid catalyst temperatures reach values higher than 1000 °C while the gas remains relatively cool by utilizing a reaction environment geometry that allows to reduce the contact time at the entrance of the catalytic bed to few milliseconds and that allows the expansion of the reaction volume when the temperature and the mole flow increases due to the progressing of the reaction. This effect is obtained by adopting a truncated shape geometry of the catalytic bed and catalyst geometrical features that allow to reduce the pressure drop inside the reaction zone.

Accordingly, it has been found that in these short contact time conditions, the methane conversion largely depends on the O₂/C ratios while is almost unaffected by the addition of steam and CO₂. This addition instead modifies the H2/CO ratios in the produced synthesis gas clearly indicating that the reactivity is largely determined by the direct partial oxidation [16] and by the RWGS reaction [4].

FIG. 8 shows qualitative pictures of the Enthalpy/Temperature profiles obtained at (A) low mass velocity, high contact time, tubular geometry of the catalytic bed and (B) high mass velocity, short contact time, truncated cone geometry of the catalytic bed. The black solid line represents the total enthalpy variation.

FIG. 9 shows the main zones of the SCT-CPO reactor including a truncated cone reaction zone.

The cylindrical first portion includes a mixing inlet zone and a first thermal shield pre-heating zone.

The central second portion includes a reaction zone, The cylindrical third portion includes a second thermal shield and a reactor exit zone.

The angle α shown in FIG. 9 is clearly lower than 80° and preferentially comprised between 75° and 30°.

The other geometrical features namely the: i) truncated cone inlet radius R1, ii) the truncated cone exit radius R2, iii) the truncated cone length L and the catalytic bed filling are designed for allowing pressure drop values (AP) inside the catalytic bed between 0.1 and 10 ATM and preferentially between 0.5 and 5 ATM.

To this purpose the ratios R1/R2 must be comprised between 0.9 and 0.1 and preferentially between 0.8 and 0.4 and the shapes of the filling of the catalyst bed need to be defined for minimizing the pressure drop conditions by utilizing pelletized or monolith structures and their combinations.

It has also been noted that the existence of a non-thermal equilibrium between the gas and the solid phases and this has been explained considering that the chemical heat generated at the surfaces and emitted by radiation, is absorbed, and scattered much better by the solid than by the gaseous phase and is transferred along the catalytic bed from the hotter towards the cooler points smoothing the solid surface temperatures. The main experimental observations on the thermo-chemical properties of the SCT environments, performed after optimization of the reaction environment characteristics, are synthesized as follows:
i) the temperature of the solid phase raises steeply at the beginning of the bed and the temperature profiles are smoothed through radiative and conduction mechanisms in the axial and radial directions
ii) temperature differences are originated between the gas and the solid phases,
iii) local surface temperatures values result higher than the adiabatic temperatures
iv) gas temperatures are always lower than the adiabatic temperatures and gradually increase from the entrance to the exit of the bed

It has also been found that part of the reaction heat is transferred towards the incoming reactants inside the first thermal shield zone and in this way a reactant pre-heating internal to the reactor is also achieved.

Accordingly, in the described process solutions, the CO₂ emissions are mainly related to the E.E. consumption required for:
i) compressing the feedstock (compression energy that would be required for any syngas production technology),
ii) for obtaining the O₂ flow for instance with an Air Separation Unit (ASU),
iii) in some cases, for performing steam electrolysis and in some others for operating an electrified reverse water gas shift reactor (E-RWGS)

Noteworthy, when steam electrolysis is included in the process architectures here described, not only the H₂ stream participate to the process flows and particularly to the E-RWGS and/or the A-RWGS sections, but also the co-produced O₂ streams are utilized by the SCT-CPO reactor, and this increases the energy efficiency of the overall solutions.

In conclusion it is disclosed that only the SCT-CPO reactor with the features above described allows the recycle of the F-T tail gases and of the off-gases produced by the separation and/or upgrading of the F-T primary products, for their utilization in the synthesis gas production. These gases mainly include C1-C4 hydrocarbons with minor amounts of C5-C10 hydrocarbons, and these molecules are mainly constituted by saturated hydrocarbons with a component of unsaturated hydrocarbons. Particularly the unsaturated hydrocarbons would originate carbon formation reactions in the known syngas production technologies but this problem would also be present in SCT-CPO reactors with features different from those above described. Indeed, tubular cylindrical SCT-CPO reactors would be immediately clogged by carbon formation reactions due to heterogenous cracking and polymerization reactions of the unsaturated molecules particularly occurring before the catalytic bed and by unselective radical reactions occurring in the gas phase either in the inlet and mixing zones and in the catalytic zones.

1-9. (canceled)

10. A method to produce hydrocarbon compounds by converting syngas via a Fischer-Tropsch process, wherein the syngas comprises a part produced via a short contact time catalytic partial oxidation process and a part produced by reverse water gas shift process, wherein:
A) the short contact time catalytic partial oxidation process uses a feedstock comprising:
i) a first stream comprising a mixture comprising carbon dioxide included in one or more of natural gas, associated gases, off-gases of industrial activities, biogas, blast furnace gases, coke oven gases, direct reduction gases and carbon dioxide captured from gaseous streams, the carbon dioxide being from 5 to 50% v/v of the mixture;
ii) a second stream comprising oxygen or air enriched with oxygen, wherein the oxygen is obtained from electrolysis of water and from air, and the electrolysis of water produces also hydrogen which is mixed to the syngas and fed to the Fischer-Tropsch process;
iii) a third stream comprising tail gas released from the Fischer-Tropsch process;
wherein the short contact time catalytic partial oxidation process is carried out in a reactor on a catalytic bed comprising a portion with truncated cone geometry operated at a gas hourly space velocity from 15,000 to 500,000 h⁻¹; and
B) the reverse water gas shift process uses a feedstock comprising a mixture of hydrogen and carbon dioxide, wherein:
the carbon dioxide is from 10 to 70% v/v of the mixture;
the hydrogen is from 10 to 70% v/v of the mixture; and
the liquid hydrocarbon compounds are collected from a Fischer-Tropsch reactor in which the Fischer-Tropsch process is carried out.

11. The method of claim 10, wherein the second stream comprises steam.

12. The method of claim 11, wherein the hydrogen from 10 to 70% v/v of the mixture is produced by electrolysis of the steam.

13. The method of claim 10, wherein the hydrogen from 10 to 70% v/v of the mixture is produced by the electrolysis of the water.

14. The method of claim 10, wherein the oxygen from air of the step A) ii) is obtained via cryogenic air separation, vacuum pressure swing adsorption, or membrane separation.

15. The method of claim 10, wherein the reverse water gas shift process is carried out in a reactor heated by electrical means.

16. The method of claim 10, wherein the reverse water gas shift reactor is heated by combustion of fuel.

17. The method of claim 10, wherein a portion of the syngas produced in the short contact time catalytic partial oxidation process is fed to the reverse water gas shift process to increase the amount of hydrogen fed from the hydrolysis of water.

18. The method of claim 17, wherein the ratio of hydrogen/carbon dioxide fed to the reverse water gas shift reactor is at least 1/1 v/v.

19. The method of claim 10, wherein the reverse water gas shift reactor is an electrified reverse water gas shift reactor (E-RWGS) or an autothermal reverse water gas shift reactor d (A-RWGS).

20. An apparatus for producing synthetic hydrocarbon compounds according to the method of claim 10, comprising:
a short contact time catalytic partial oxidation reactor including a first portion having a cylindrical shape consisting of an inlet a mixing zone and a thermal shield zone, a second portion containing a catalytic bed having a truncated cone shape, and a third portion having a cylindrical shape with a diameter greater than the diameter of the first cylindrical portion, followed by a second thermal shield zone;
wherein in the second portion having the shape of a truncated cone an upper base is smaller than a bottom base;
wherein the upper base of the truncated cone is joined to the first cylindrical portion and the bottom base is joined to the third cylindrical portion; and
wherein an external angle (α) of the truncated cone at the upper base is lower than 85°.

21. The apparatus of claim 20, wherein the external angle (α) of the truncated cone at the upper base is between 75° and 30°.

22. The apparatus of claim 20, wherein the upper base of the catalytic bed having the shape of a truncated inverted cone has a diameter R1 and the bottom base has a diameter R2, wherein the ratio R1/R2 is from 0.9 to 0.1.

23. The apparatus of claim 22, wherein the ratio R 1/R2 is from 0.8 to 0.4.

24. The apparatus of claim 20, comprising a reverse water gas shift reactor configured to carry out the reverse water gas shift process.

25. The apparatus of claim 24, wherein the reverse water gas shift reactor is heated by combustion of fuel.

26. The apparatus of claim 24, wherein a portion of the syngas produced in the short contact time catalytic partial oxidation process is fed to the reverse water gas shift process to increase the amount of hydrogen fed from the hydrolysis of water.

27. The apparatus of claim 26, wherein the ratio of hydrogen/carbon dioxide fed to the reverse water gas shift reactor is at least 1/1 v/v.

28. The apparatus of claim 24, wherein the reverse water gas shift reactor is an electrified reverse water gas shift reactor (E-RWGS) or an autothermal reverse water gas shift reactor d (A-RWGS).
